(19) United States
(12) Patent Application Publication
(10) Pub. No.: US 2008/0160494 A1
(43) Pub. Date: Jul. 3, 2008

(54) Erasable board cover system

(76) Inventors: Richard Leifer, Melville, NY (US); Alan Randmae, Northport, NY (US); Gabe Neiser, Port Jefferson Station, NY (US); John Castellano, Commack, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/646,646

(22) Filed: Dec. 28, 2006

(51) Int. Cl. B43L 1/00

(52) U.S. Cl. 434/408

(57) ABSTRACT

An erasable board cover system is provided to enable the selective covering and concealment of the writing surface of the erasable board. The cover system can include a retractable cover that is adapted to slidably cover the erasable board using edge mounted tracks and reels and cords. In other embodiments the cover is a retrofit item that can be disposed over a erasable board in a stationary, static manner, or can be retractably mounted over the erasable board. A manual knob or an electric motor can control the deployment and/or retraction of the erasable board cover in the retractable embodiment. A locking mechanism is provided and configured to secure and prevent movement of, or the removal of, the cover when in a locked position.

### BACKGROUND

1. Field of Technology

The present invention generally relates to erasable boards, and more particularly, to a system and method for covering the exposed writing surface of an erasable board to prevent unauthorized viewing/access to the written subject matter the expose writing surface.

2. Discussion of Related Art

Most erasable black boards have been replaced in homes, offices and schools with so-called ‘white boards’ or erasable boards which typically have a bright white, writable surface comprised of a polyester film. Erasable markers and the like are typically used for writing on white boards.

It is often desirable to leave written material on a white board for a period of time. That is, it is often not feasible to immediately erase all written material after each use, for purposes of presentation to other parties, etc. However, a white board may contain written material which is confidential or other sensitive information which is not desired to be disclosed to unauthorized viewers. Existing means for concealing the contents of a white board may include, e.g., a pull-down screen, but such means are easily tampered with and/or removed, thus freely revealing any confidential written contents of the underlying white board.

Thus, it would be desirable to provide a secure erasable board covering system which is efficient, tamper-proof, practical and adaptive to different white board units.

### SUMMARY

It is therefore an aspect of the present principles to provide an improved erasable board covering system which securely conceals a white board and is resistant to tampering by unauthorized users in an efficient, practical manner. Advantageously, the present principles eliminates the need to erase or remove erasable boards containing sensitive subject material written thereon when visitors or employees are present who might pose a security risk. An erasable board cover according to the present principles is attachable, rollable or otherwise positionable over a white board to securely conceal the front writable surface of the erasable board from view. In a preferred embodiment, a rollable (‘slidable’) cover is provided, which is described below with reference to FIGS. 1-5.

According to a first aspect, an erasable board cover system is provided having An erasable board having a front writable surface including a left and a right edge and a cover configured to be extendable and retractable over substantially the entire erasable board writable surface via a reel system. The cover includes a top edge and at least two vertical edges substantially parallel to said left and right edges of the erasable board surface. At least two side panels are provided, each panel being affixed to one of said left and right edge of the erasable board and each panel being configured to overlap each of said two vertical edges. A locking mechanism is provided configured to secure and prevent movement of the cover when in a locked position.

According to another aspect, a method of covering an erasable board is provided having the steps of providing an erasable board having a front surface including a left and a right edge, providing a cover configured to be extendable and retractable over substantially the entire erasable board surface via a reel system, the cover including a top edge and at least two vertical edges substantially parallel to said left and right edges of the erasable board surface, providing at least two side panels, each panel being affixed to one of said left and right edge of the erasable board, the panels being configured to overlap each of said two vertical edges, and providing a locking mechanism configured to secure and prevent movement of the cover when in a locked position.

According to yet another aspect of the present principles, an erasable board cover is provided having a cover configured to be extendable and retractable via a reel system, the cover including a top edge and at least two vertical edges, and at least two side panels, the panels being configured to overlap each of said two vertical edges. A locking mechanism is provided configured to secure and prevent movement of the cover when in a locked position.

These and other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numerals denote similar components throughout the views:

FIG. 1 is a front view of an exemplary white board cover system according to an aspect of the present principles;

FIG. 2 is a front perspective view of an exemplary white board cover system in a fully closed position according to an aspect of the present principles;

FIG. 3a is a top perspective interior view of the right-side rotating mechanism of the white board cover system according to one aspect of the present principles;

FIG. 3b is a top perspective interior view of the right-side rotating mechanism of the white board cover system according to another aspect of the present principles;

FIG. 4 is a top perspective interior view of a left-side reel apparatus according to an aspect of the present principles; and

FIG. 5 depicts a partial top view of a left side edge of a white board cover system according to an aspect of the present principles.

### DETAILED DESCRIPTION

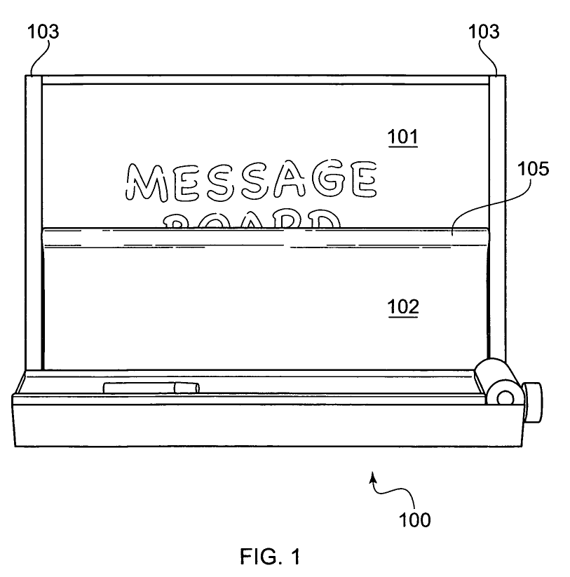

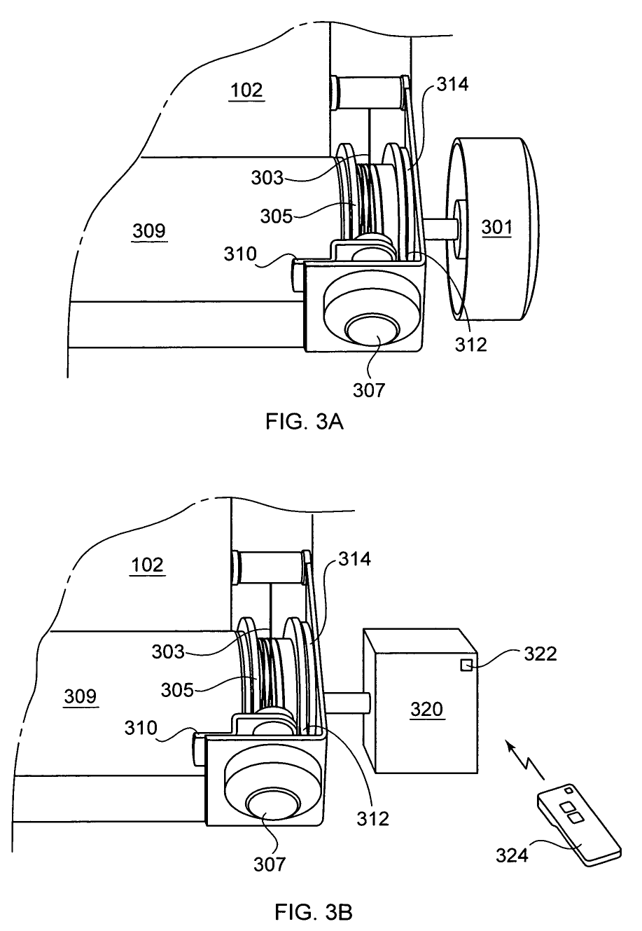

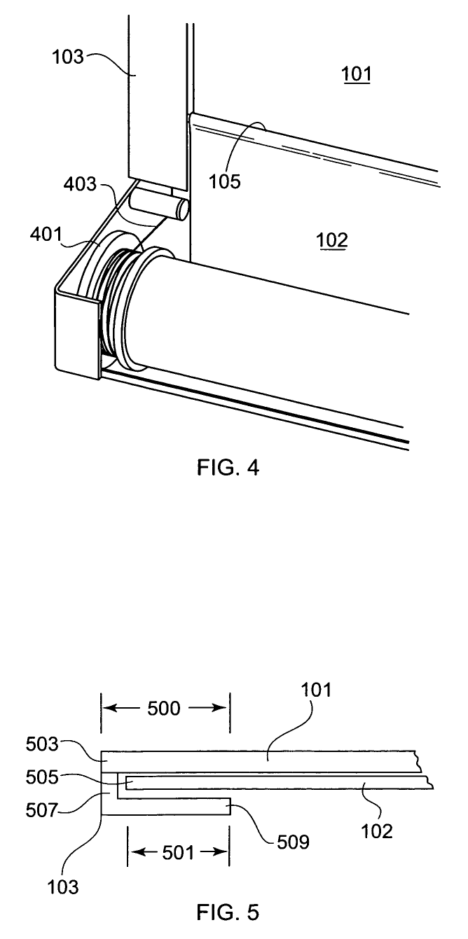

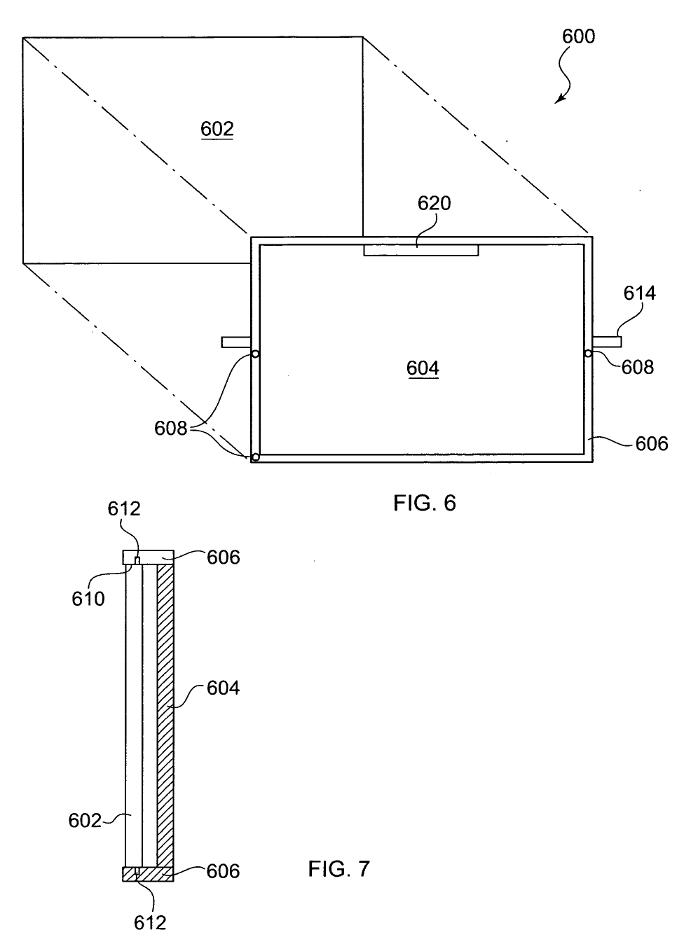

FIG. 1 depicts a front view of an exemplary erasable board cover system according to an one aspect of the present principles. A erasable board cover system 100 includes a retractable erasable board cover 102 configured to be rollable over a erasable board 101 via a reel system (shown in FIGS. 3 and 4). The cover system 100 may be integrated into the manufacture of the erasable board, or alternatively, the cover system may be provided and configured as an retrofit add-on to existing erasable boards. The cover system 100 includes at least two side panels 103 which are configured to overlap the left and right vertical edges of the erasable board cover 102. The two vertical edges (e.g., 505 in FIG. 5) of the cover 102 run substantially parallel to left and right edges (e.g., 503) of the erasable board surface.

The side panels 103 are preferably comprised of a rigid material and are configured to prevent the vertical edges of the cover 102 from being pulled back, thus preventing unauthorized viewing of the underlying erasable board. FIG. 5 depicts an exemplary top view of a left side of a erasable board cover system according to an aspect of the present invention, showing a left edge 503 of the erasable board 101. According to an exemplary embodiment, each side panel 103 may comprise an L-shaped configuration having a first portion 507 affixed to the erasable board 101 and a second portion 509 extending over a vertical edge 505 of the cover 102. A width 500 of each side panel preferably is at least about 0.5 inch, with preferably at least a minimum of about 0.4 inches of overlap 501 over each vertical edge 505 of the erasable board cover 101. Those of skill in the art will recognize that these dimensions may vary greatly without departing from the spirit of the present principles and that these values are provided as and exemplary implementation.

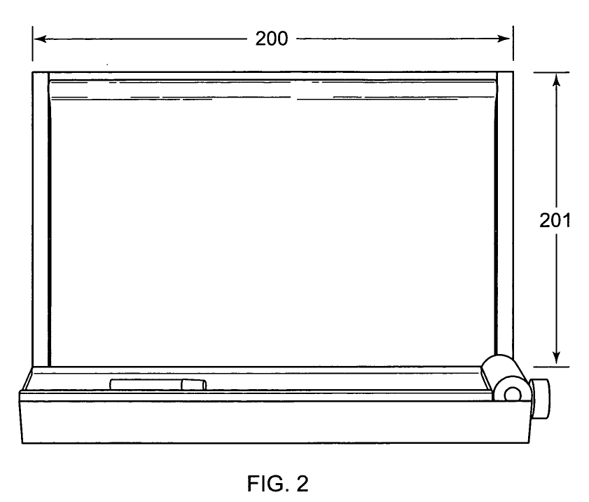

FIG. 2 is a front perspective view of an exemplary erasable board cover system in a fully closed or secured position according to an aspect of the present invention. The cover 102 may be provided in various widths 200 according to the dimensions of the erasable board to be covered and is vertically extendable along the entire height 201 of the erasable board 100 so as to fully cover the entire surface of the erasable board when in a closed position. Preferably, the cover 102 may be extended across the erasable board from a bottom to top direction and is enabled to be extendable/retractable via a reel system, as shown in FIGS. 3 and 4. Those of skill in the art will recognize that the orientation of the erasable board cover system 100 may be changed without departing from the spirit of the present principles. For example, the orientation may be from left-to-right, from right-to-left.

The reel system may include a set of left and right side reels 305, 401, respectively, each having a retractable cord 303, 403 wound thereon. Preferably, one end of each cord 303, 403 is attached to the reel while a second end is affixed to a top edge 105 of the cover 102, thus preventing slack from being developed in the cover 102 by the push-pull cord system. For example, in a retracted position, the cover 102 is caused to be wrapped around a center reel 309 so as to allow the erasable board 101 to be viewed. As the center reel 309 is turned, either by knob 301 or a motor (not shown), the cords 303, 403 and corresponding reel mechanisms, enable the raising and lowering of the terminated end or top edge 105 of the cover 102 without bunching or stretching. The slack or tension is predetermined and preset at the manufacturing stage of the system, and may be controlled by a spring or other known means to maintain a predetermined tension. During use, each reel and cord assembly is covered (as shown, e.g., in FIGS. 1 and 2) to prevent tampering. Those of skill in the art will recognize that the sliding capability of the cover 102 can be performed in various other ways, without departing from the spirit of the present principles. For example cords 303, 403 could be replaced by linear bearings extending the entire length of the side panels, with the underside of the cover having an appropriate complimentary linear bearing track, etc.

It is to be contemplated that a stop mechanism (not shown) may also be provided to prevent the leading edge 105 of the cover 102 from being drawn into the real housing.

The reel system may include a knob 301 functionally connected to the reel 305 or 401 for enabling rotation of the reels and thereby provide, manual extension/retraction of the cover 102 at various increments of extension. In an alternate embodiment, a motor 320 or other automated means can be provided in addition to or in lieu of the manual knob 301. As shown in FIGS. 3a and 3b, a clutch with a torque limiter 314 is incorporated into the cover system. The type of clutch could be referred to as slip clutch or any other known device for limiting applied torque. In the present implementation, the torque setting for the clutch 314 would be just under the force to failure point of the cover system mechanism, including the reels, the cords, the screen, the frame, etc.). Those of skill in the art will recognize that various factors are involved in such torque limitation, such as, for example, the strength of the cords and the screen, and possibly the size of the reels, etc.

In use, when the surface of a erasable board 101 is desired to be entirely concealed, the cover 102 is caused to be extended to the fully closed position as shown e.g., in FIG. 2. This position may be locked into place via locking mechanism 307 to prevent unauthorized retraction of the cover 102. The locking mechanism 307 includes a locking pawl 310 which selectively engages one or more protrusions 314 on reel 305 and thereby prevents rotation of the same. The lock 307 may be provided at either or both reel device(s) 305, 401 to secure the reel in various positions. The cover 102 may be raised and lowered in vertical increments to cover or expose any amount of the erasable board 101 as desired. For example, FIG. 1 shows the cover 102 at an approximately halfway position. Upon reaching the desired position, the cover 102 may be locked into place via lock 307 to prevent unauthorized movement of the cover 102.

FIG. 3b shows another embodiment where a motor 320 replaces the manual rotating knob 301. The motor 320 can be any suitable type of motor, and can include a remote receiver 322 for receiving wireless commands from a remote control device 324.

Preferably, the cover 102 is comprised of a durable, tear-resistant, highly abrasion resistant and/or ballistic material which has a high tear strength and is designed to be particularly resistant to cutting, for providing further security against tampering and unauthorized viewing of the erasable board surface 101. Such materials may comprise, e.g., nylon Cordura®, nylon composites with or without coatings, materials made out of synthetic fiber comprising poly-paraphenylene terephthalamide which is constructed of para-aramid fibers (e.g., Kevlar®), etc. The top edge 105 of the cover 102 is preferably positioned as close as possible to the surface of the erasable board 101 during all cover positions (e.g., from fully open to fully closed and all positions in between) without obstructing the movement of the cover 102 across the top of erasable board 101. The leading edge 105 may include a reinforcing element comprising e.g., a rigid structure (e.g., a metal or plastic bar) affixed along its horizontal length to prevent unauthorized viewing of the erasable board surface from the top. This reinforcing element can also function as the stop mechanism discussed above.

The side board panels 103 are comprised of a rigid, shatterproof, impact resistant and/or ballistic material to similarly afford protection against tampering, breakage and cutting. Such materials may comprise, e.g., ballistic plastics, metals, nylon composites, etc.

FIG. 6 shows another embodiment of the erasable board cover system 600 according to the present principles. The erasable board 602 is covered by a single cover 604 that is adapted to fit over the erasable board and be secured thereto. The cover 604 can have a frame 606 or other suitable perimeter for aesthetic purposes. The frame or outer periphery preferably includes a lock access 608 which can be positioned anywhere on the frame 606 as shown. The type of locking mechanism employed by the frame to attach the same to the erasable board, will determine whether one or more locks 608 are required. For example, a friction type lock 612 can be integrated into the frame 606 such that only one lock 608 is required. However, it is also contemplated that the mechanism required for single actuation of a lock that is activated around the perimeter of the cover 604 could be complex and reduce the potential for commercialization of the product. As such, more than one lock 608 can be provided e.g., on opposing sides of cover 604, such that the friction locking mechanism or other locking mechanism can be integrated more cost effectively during manufacturing, without degrading or otherwise compromising the integrity of the locking system.

FIG. 7 shows a cross section of the cover 604 as positioned over the erasable board 602. As shown, the frame 606 includes a rearward extending portion that is adapted to engage the edges 610 of the erasable board 602. Although a friction lock 612 is shown with corresponding locks 608, it is also contemplated that frame 606 be designed of such a material so as to provide a secure friction fit against the edges 610 without requiring any additional locking mechanism in the frame 606. In this embodiment, the frame would have some resilience that would allow the snug friction fit between the frame 606 and the edges 610 of the cover 602. Those of skill in the art will recognize that other mechanisms for securing the cover 604 over the erasable board 602 may be employed without departing from the spirit of the present principles. For example, frame 606 may include brackets 614 that extend therefrom and allow the cover 604 to be adhered to the wall or other structure on which the erasable board 602 is mounted. A locking hasp or other selectively lockable bracket could be used as bracket 614 in this implementation in order to provide securing covering of the erasable board, as required.

In other embodiments, the cover 604 can include a light 620 for illuminating the front surface thereof. In this instance, cover 604 can be used to either display some art work, or may even be manufactured to include a preferred design, corporate logo, art, or any other desired images.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

What is claimed is:

1. An erasable board having a writable surface, the erasable board comprising:
a cover adapted to fit over a writable surface of the erasable board and selectively conceal the writable surface from view.

2. The erasable board system of claim 1, wherein said cover further comprises:
an outer peripheral frame;
connecting means for releasably connecting the cover portion to the erasable board; and
locking means disposed within said frame and adapted to engage peripheral edges of the erasable board, said locking means securing said cover from removal once positioned over the writable surface of the erasable board.

3. The erasable board system of claim 1, wherein said cover portion further comprises a light for illuminating a front exposed surface of the cover when positioned over the erasable board.

4. The erasable board covering system of claim 1, further comprising a light positioned to illuminate the cover when disposed over the writing surface of the erasable board.

5. An erasable board covering system comprising:
an erasable board cover positioned to retractably cover a writable surface of the erasable board when in a deployed position.

6. The erasable board covering system of claim 5, wherein said erasable board cover further comprises a manual knob for extending and retracting the cover.

7. The erasable board covering system of claim 5, further comprising means for incrementally moving said erasable board cover into said deployed position.

8. The erasable board covering system of claim 5, further comprising a motor connected to said retractable cover for selectively deploying and retracting the cover.

9. The erasable board covering system of claim 8, wherein said motor further comprises a remote wireless receiver.

10. The erasable board covering system of claim 9, further comprising a remote control for wirelessly controlling the deployment and retraction of said cover.

11. An erasable board cover system for selectively covering the writable surface of the erasable board, the cover system comprising:
a cover configured to be extendable and retractable over writable surface of the erasable board via a reel system, the cover including a top edge and at least two vertical edges substantially parallel to left and right edges of the erasable board; and
a locking mechanism configured to secure and prevent movement of the cover when in a locked position.

12. The system of claim 11, further comprising at least two side panels, each panel being affixed to one of the left and right edge of the erasable board, the panels being configured to overlap each of said two vertical edges; and

13. The system of claim 12, wherein each side panel comprises a width of at least 0.5 inches.

14. The system of claim 12, wherein each side panel comprises a first portion affixed to one of said left and right edges of the erasable board, and a second portion overlapping a vertical edge of the cover.

15. The system of claim 12, wherein each side panel overlaps each vertical edge of the cover by at least 0.4 inches.

16. The system of claim 11, wherein the locking mechanism is configured to prevent movement of the reel when in a locked position.

17. The system of claim 11, wherein the reel system comprises at least two reels each having a cord, wherein a first end of the cord is attached to the reel and a second end of the cord is attached to the top edge of the cover.

18. The system of claim 11, wherein the reel system includes a stop mechanism configured to hold the reel at a desired position.

19. The system of claim 11, wherein the top edge includes a reinforcing element affixed along its horizontal length.

20. The system of claim 11, wherein the cover is configured to be extendable over the erasable board from a bottom to a top direction.

21. The system of claim 11, further comprising a light positioned to illuminate the cover when disposed over the writing surface of the erasable board.

22. The system of claim 11, wherein said cover can be incrementally extended to cover the cover at least some portion of the writable surface of the erasable board.
